(19) United States
(12) Patent Application Publication
(10) Pub. No.: US 2006/0061678 A1
(43) Pub. Date: Mar. 23, 2006

(54) Digital cameras and image pickup methods

(75) Inventor: Hitoshi Yamazaki, Tokyo (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: Casio Computer Co., Ltd., Tokyo (JP)

(21) Appl. No.: 11/225,775

(22) Filed: Sep. 13, 2005

(30) Foreign Application Priority Data
Sep. 17, 2004 (JP) 2004-271238

(51) Int. Cl. H04N 5/232

(52) U.S. Cl. 348/349

(57) ABSTRACT

When a shutter button of an operation unit is depressed, a controller controls a lens unit driver such that the focal position of a lens unit is continuously changed. During this operation, an image pickup unit picks up a plurality of different images of a subject successively and then stores them in an image memory. An image processor then calculates contrast values of the picked-up images stored in the image memory and specifies respective focused parts of the images. A display controller then displays the picked-up images on a display such that their specified focused parts are displayed specifically. The controller then stores on a memory card images specified by a user from among the displayed images.

### CROSS-REFERENCE TO RELATED APPLICATIONS

This application is based upon and claims the benefit of priority from the prior Japanese patent Application No. 2004-271238, filed on Sep. 17, 2004, the entire contents of which are incorporated herein by reference.

### BACKGROUND OF THE INVENTION

1. Field of the Invention

The present invention relates to digital cameras and methods for obtaining a good image easily from among a plurality of images of any subject picked up successively.

2. Background Art

Image pickup devices such as digital cameras proposed hitherto have an auto-focus (AF) function. With the AF function, the camera is generally focused on a subject appearing at substantially the center of a frame thereof. Thus, when a scene in which, for example, two persons stand side by side is picked up in such a manner that a point between the two persons coincides with the center of the frame, the camera can be focused on a background of the scene. In order to avoid such failure, an image pickup method is used which comprises half depressing the shutter button for focusing purposes in a state in which the camera is focused on a desired one of the two persons whose image is caused to appear at the center of the frame and then adjusting the direction of the camera such that a desired compositional arrangement of the image is obtained (called “Auto-Focus lock”).

This method, however, cannot be performed successfully unless the user has much experienced in the image pickup and beginners fail often in the image pickup.

In order to solution such problems, a multi-AF technique is widely used that comprises causing the camera to be focused on a subject at a plurality of positions within the frame. According to this technique, the aforementioned troubles can be solutioned even when the focus lock method is not used. However, this method is not appropriate for intentional focusing. Thus, the user must change the AF mode to a self-determination mode in which the camera itself determines automatically at which point the camera should be focused on the subject or a mode in which the user specifies while picking up images according to the user's image pickup intention, which is troublesome.

Tokkai Hei 11-313240 publication proposes a method for picking up a plurality of images of an object successively while changing the focal distance of the camera in response to a single shutter button command, extracting and combining focused parts of the picked-up plurality of images, and then obtaining an image focused throughout an overall range of a nearest end-infinity (so-called “pan focus method”).

According to this method, the user need not consider the focusing operation of the camera. However, since this method intends to obtain a pan focus image, an image whose background is shaded off cannot be obtained.

### SUMMARY OF THE INVENTION

It is therefore an object of the present invention to provide a digital camera capable of easily obtaining a good focused image based on a plurality of focusing evaluation values given respectively to a plurality of images of any subject picked up successively.

Another object of the present invention is to provide a digital camera capable of easily obtaining as a good focused one an image having a maximum focusing evaluation value based on a plurality of focusing evaluation values given respectively to a plurality of images of any subject picked up successively.

A first main feature of the present invention is that in response to an image pickup command given, for example, by operation of a shutter button the focal distance of a lens unit is changed continuously while a plurality of images are being picked up. Focused parts of the respective picked-up images are specified and displayed specifically and distinguishably

Another feature of the present invention is that in response to an image pickup command given, for example, by operation of a shutter button the focal distance of a lens unit is changed continuously while a plurality of images are being picked up. Focused parts of the respective picked-up images are specified. In addition, an image including a part having a maximum one among focusing evaluation values of parts of the plurality of images at each same position is displayed specifically and distinguishably

### BRIEF DESCRIPTION OF THE DRAWINGS

The accompanying drawings, which are incorporated in and constitute a part of the specification, illustrate presently preferred embodiments of the present invention and, together with the normal description given above and the detailed description of the preferred embodiments given below, serve to explain the principles of the present invention in which:

FIG. 1 is a block diagram indicative of the internal structure of a digital camera according to an embodiment 1 of the present invention;

FIGS. 2A and 2B are a front and a back view, respectively, of the digital camera of the embodiment 1;

FIG. 3 is a flowchart indicative of an image pickup process to be performed in the embodiment 1;

FIG. 4 is a flowchart indicative of an image evaluation process to be performed in the FIG. 3 image pickup process;

FIG. 5 is a flowchart indicative of an image evaluation/display process to be performed in the image pickup process;

FIG. 6 is a flowchart indicative of an image evaluation process according to an embodiment 2 of the invention;

FIG. 7A shows one example of a compositional arrangement of an image to be picked up in the image pickup process, and FIG. 7B illustrates the positional relationship between the digital camera and the respective subjects in this compositional arrangement;

FIG. 8 illustrates blocks of an image set in the image evaluation process in the embodiment 2;

FIG. 9 illustrates an evaluation value table created in a memory of the digital camera in the embodiment 2;

FIG. 10 illustrates a plurality of blocks set in the image evaluation process to be performed in the embodiment 2;

FIGS. 11A and 11B illustrate a picked-up scene picture where rectangular focusing indicators are formed on a subject image and a second picture including a plurality of selectable thumbnails on some of which focusing indicators are formed respectively, in the second embodiment;

FIG. 12A illustrates a scene image displayed in a display process in which scene image the image of a distant subject is in focus, and FIG. 12B a second scene image in which the image of a closer subject is in focus;

FIG. 13 is a flowchart indicative of an image storing process to be performed in an embodiment 3; and

FIG. 14 is a flowchart indicative of a stored image arranging process to be performed in the embodiment 3.

### DESCRIPTION OF THE PREFERRED EMBODIMENTS

### Embodiment 1

In this embodiment, in response to a single image pickup command, a plurality of picked-up images are picked up successively while the camera focal distance is being changed. Focused parts of the respective images are displayed specifically such that the user can select and store images having desired focused parts from among the displayed images.

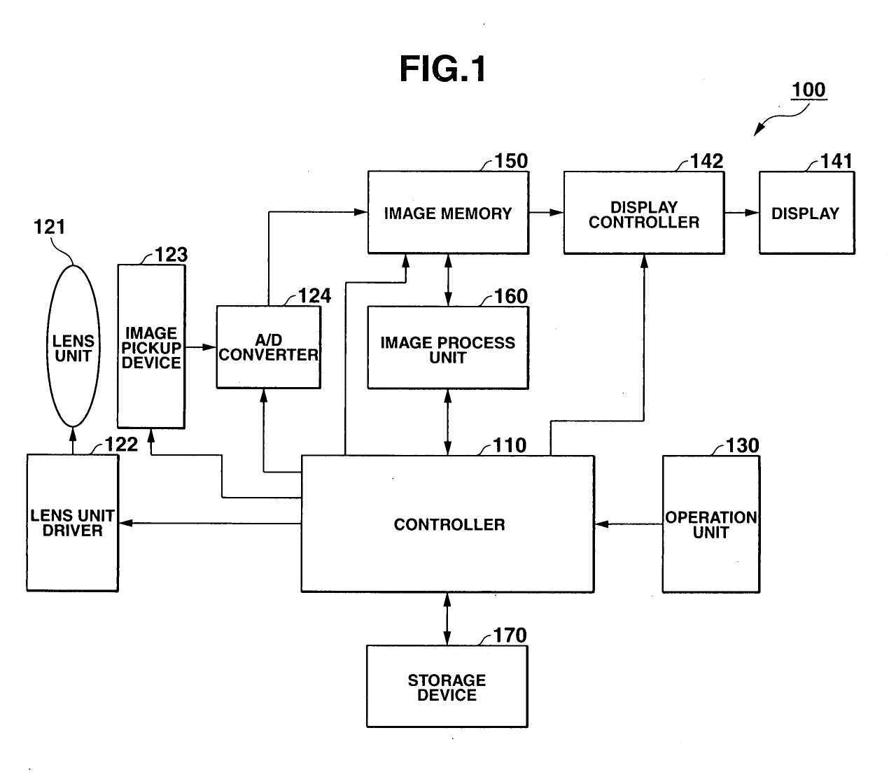

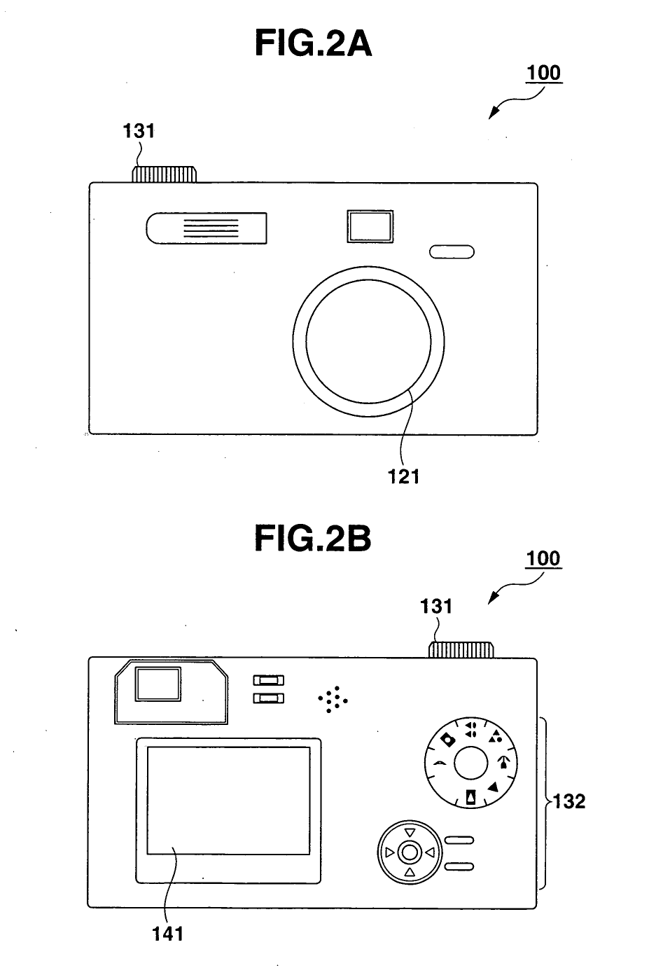

The structure of a digital camera according to the embodiment 1 will be described with reference to FIGS. 1 and 2. As shown, the digital camera 100 comprises a controller 110, a lens unit 121, a lens unit driver 122, an image pickup element 123, an A/D converter 124, an operation unit 130, a display 141, a display controller 142, an image memory 150, an image processor 160, and a memory 170.

Controller 110 comprises a CPU that controls the respective elements of camera 100.

Lens unit 121 comprises optical elements such as lenses and condenses that focus incident light from a subject on image pickup unit 123 for imaging purposes.

Lens unit driver 122 comprises a power unit such as a drive motor and a power transmission unit that includes a shaft and gears that transmit power from the motor to lens unit 121, thereby driving the optical members of the lens unit under control of the controller 110. In the embodiment, lens unit 121 should have an auto-focus function that changes its focal distance when lens unit driver 122 is driven.

Image pickup element 123 comprises, for example, a CCD (Charge Coupled Device) that converts visible rays of light received from lens unit 121 to electric charges.

A/D converter 124 converts electric charges (or an analog signal) from CCD 123 to digital image data.

Operation unit 130, operated by the user, delivers signals representing respective commands to controller 110 in accordance with the user's manual operation. Operation unit 130 may comprise at least a shutter button 131 and an operation input unit 132 (see FIG. 2).

Shutter button 131 is composed of a button moved upward or downward when depressed. When shutter button 131 is depressed, it delivers an image pickup start signal (hereinafter referred to as a shutter signal) to controller 110. Shutter button 131 may be composed, for example, of a release or remote control button.

Operation input unit 132 comprises predetermined operation buttons, a dial, or cursor keys such that the user can give commands that set/change various settings and modes including an image pickup mode.

Display 141 is composed, for example, of a liquid crystal display to display images obtained from image pickup element 123 and stored in memory 170 and a menu picture on which various settings can be changed. When display 141 is composed of a touch panel, it may function as an input device equivalent to operation input unit 132.

Display controller 142 controls display 141 to display an image in accordance with instructions from controller 110. Display controller 142 also cooperates with image processor 160 so as to display a processed image on display 141.

Image memory 150 is composed, for example, of a flash memory that stores digital image data converted by the A/D converter of image pickup unit 123, and image data processed, or to be processed, by image processor 160.

Image processor 160 is composed, for example, of circuits for processing images picked up by camera 100.

Memory 170 is composed, for example, of a ROM or a flash memory that stores programs to be executed by controller 110, and data (hereinafter referred to as a process mode) required for performing the respective processes. Memory 170 also comprises, for example, a removable expansion memory such as a secure digital (SD) memory card that stores required picked-up image data.

In addition to the above composition, the camera should comprise other or optional functions as the digital camera, as needed.

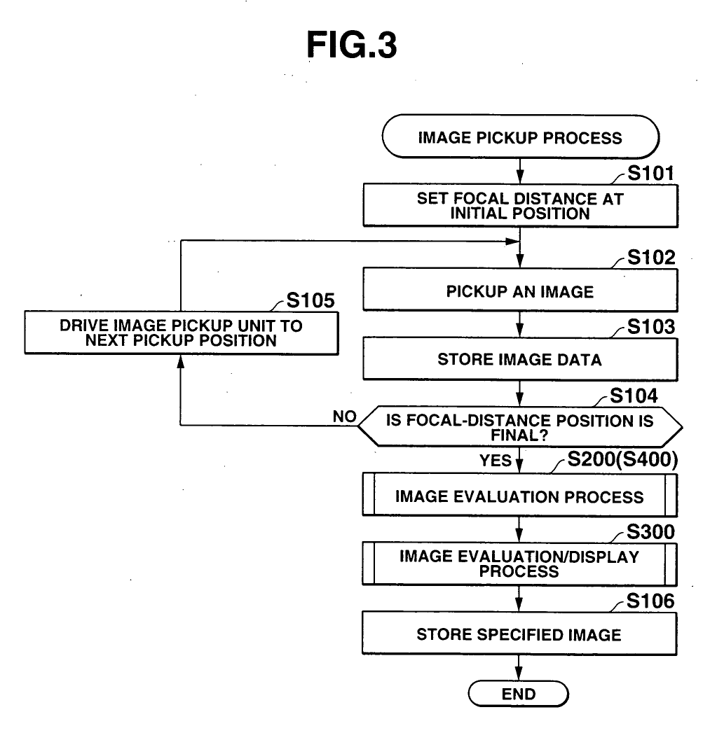

Operation of digital camera 100 will be described with reference to FIG. 3.

In camera 100, a normal image pickup mode and a focus bracket image-pickup mode are prepared. In the latter mode, a plurality of different images are picked up successively by continuously changing the focal distance in response to a single image-pickup command. Now assume that the user has selected the focus bracket image pickup mode on a menu picture displayed on display 141 by operating operation unit 130.

The image pickup process starts when the user depresses shutter button 131 by directing lens unit 121 at a desired subject.

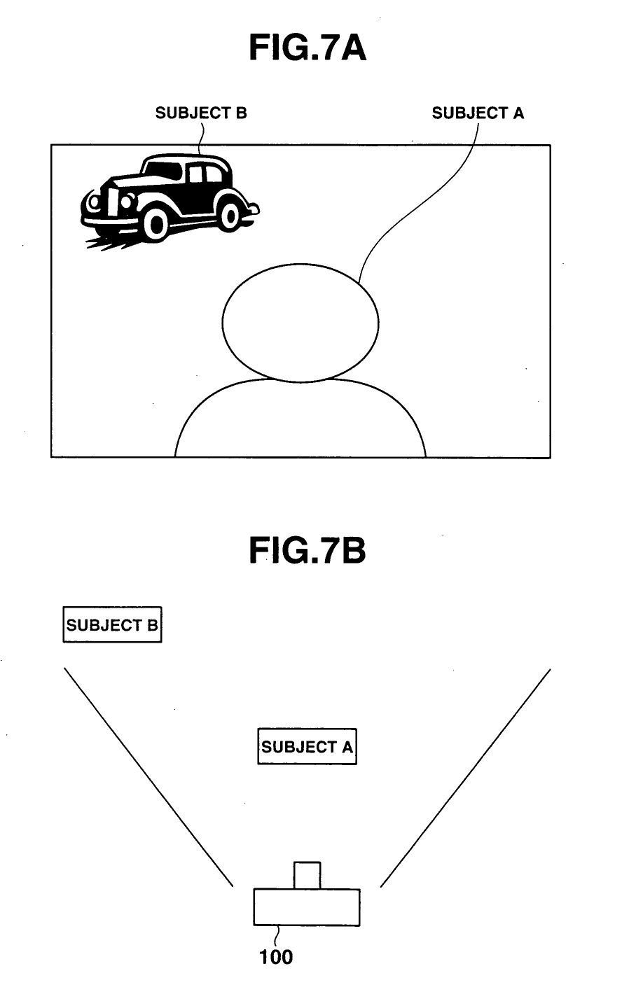

It is assumed in the embodiment that an image of a scene having a compositional arrangement of FIG. 7A is picked up. This scene includes a subject (or person) A and a second subject (or automobile) B positioned behind subject A, as shown in FIG. 7B. Camera 100 is preferably fixed on a tripod because a plurality of images are picked up successively while the focal distance of the camera is being changed.

When shutter button 131 is depressed, controller 110 controls lens unit driver 122 such that lens unit 121 moves to an initial position (or infinity) of a variable focal-distance range, in the focus bracket image pickup mode (step S101). In the embodiment, the variable focal-distance range ranges from infinity (or initial position) to a nearest (or final) position of lens unit 121.

When the lens unit 121 arrives at the initial position (where its focal position is at infinity), controller 110 causes image pickup element 123 to pick up a scene (step S102). More particularly, an image of the scene is formed on image pickup unit 123 by lens unit 121 whose focal point is at infinity. Image pickup unit 123 converts a quantity of collected light from the scene image to a corresponding quantity of electric charges. A/D converter 124 converts the quantity of electric charges to corresponding digital image data.

Controller 110 then controls image memory 150 to store the obtained digital image data on image memory 150 (step S103).

Then, controller 110 determines whether the lens unit 121 is at the final (or nearest image pickup) position at present (step S104).

The lens focus is at infinity (or the initial position) at present, and not at the final position (No in step S104). In this case, controller 110 controls lens unit driver 122 such that lens unit 121 moves to a next focal-distance position (step S105). Focal-distance positions may be provided at equal internals in the focal-distance range. For example, six focal distance positions 1, 2, 3, . . . 6 are provided in this embodiment.

Since lens unit 121 is now at the focal-distance position 1 (infinity), lens unit driver 122 drives lens unit 121 to a next focal-distance position 2.

When lens unit 121 then stops at the focal-distance position 2, image pickup unit 123 picks up an image at this position (step S102), and then stores the image data on image memory 150 (step S103).

In this way, controller 110 repeats the processing in steps S102-S105 until the determination in step S104 becomes Yes, thereby sequentially picking up and recording the images at focal-distance positions 3-6. In summary, in response to an image pickup command given by depression of shutter button 131, lens unit 121 is moved continuously to respective focal-distance positions spaced at predetermined intervals, where the subject image is picked up, thereby obtaining a plurality of successive images and storing them successively in image memory 150. When the picked-up images are stored in image memory 150, each image should be assigned an image number corresponding to the focal-distance position where the image was picked up. In this case, the images picked up at the respective focal-distance positions 1-6 are given image numbers P1-P6, respectively.

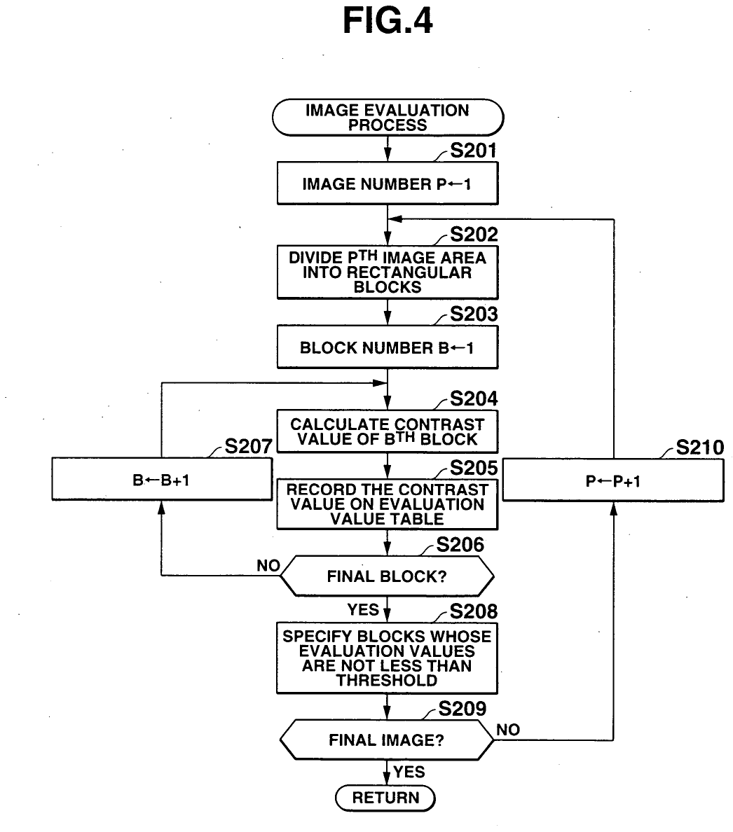

When image pickup at the focal-distance position (or closest position) 6 and its storage in image memory 150 are completed (Yes in step S104), an image evaluation process (shown by step S200) is performed by image processor 160, which is shown in a flowchart of FIG. 4. This process involves specifying an image of a high focusing evaluation value from all the image data stored in image memory 150.

First, image processor 160 substitutes “1” as an initial value into a variable P that represents an image number of a picked-up image (step S201).

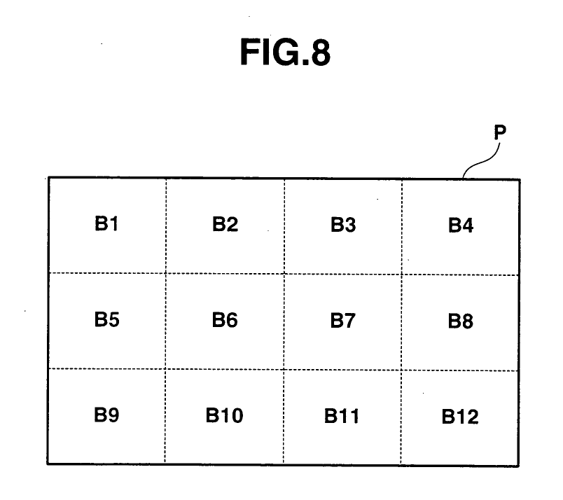

Image processor 160 then divides a P^{th} image (in this case, picture P1) into a predetermined number of rectangular blocks, for example, 3×4 blocks (B1-B12), as shown in FIG. 8 (step S202). The number and shape of blocks may be optional.

Then, image processor 160 substitutes “1” as an initial value into a variable B representing a block number (step S203), and then calculates a contrast value of block B₁ by obtaining and adding the absolute values of the differences in brightness level value between adjacent ones of pixels of that block. In the embodiment, each calculated contrast value is referred to a focusing evaluation value.

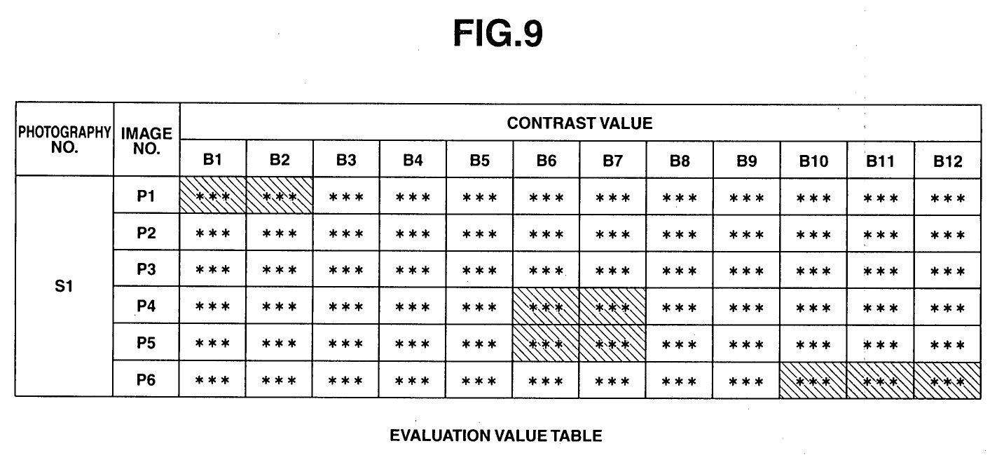

Image processor 160 then creates an evaluation value table of FIG. 9 in memory 170 and sequentially records the respective calculated contrast values on the table (step S205). The table of FIG. 9 comprises a matrix of images P picked up sequentially with a pickup number S given each time the image pickup command is given or each time shutter button 131 is depressed, and blocks B of the respective images with each cell recorded with a corresponding calculated contrast value.

When image processor 160 calculates the contrast value of a relevant block, it determines whether the present variable B representing a corresponding block number is final, or represents the final block B12 (step S206).

Since the block number is B1 (No in step S206), image processor 160 adds 1 to B and then substitutes a result of the addition into variable B (step S207). Control then returns to step S204 to calculate a contrast value of a next block (step S204).

In this way, image processor 160 repeats the processing in steps S204-S207, thereby calculating contrast values of the respective blocks B1-B12, until the determination in step S206 indicates that the block is a final one (Yes in step S206).

When the determination in step S206 indicates that the block is a final one (Yes in step S206), control passes to step S208 where image processor 160 evaluates the respective images based on the contrast values of the blocks, and more particularly, specifies blocks of each image having a contrast or evaluation value higher than a predetermined threshold.

Since blocks of the image which are in focus have a high contrast value, focused blocks can be specified based on the corresponding contrast values. For example, focused parts of the picked-up image can be specified in units of a block by using as a threshold a predetermined contrast value representing a lower focusing limit in accordance with the camera performance.

Each time a block having a contrast value higher than the threshold is specified in the image area (step S208), image processor 160 marks a corresponding cell area of the evaluation table to identify that block (for example, as hatched in FIG. 9).

After this processing, control then passes to step S209 where image processor 160 determines whether the present image number is a final one (or P6).

If not (No in step S209), image processor 160 adds 1 to variable P (representing the image number) and substitutes a result of the addition into P (step S210). Control then returns to step S202 and then repeats the processing in steps S202-S208, thereby sequentially specifying focused blocks of a next image until the determination in step S209 becomes Yes.

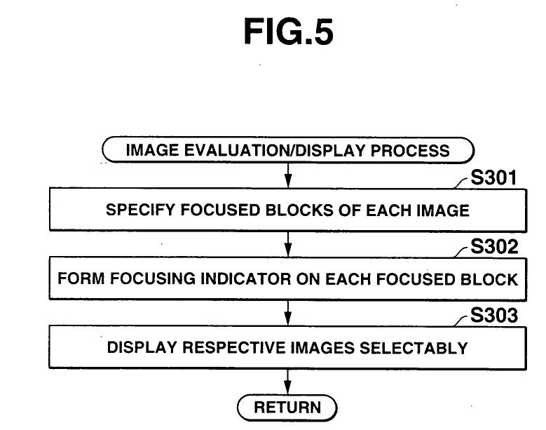

When a final focused block is specified in the final image area (Yes in step S209), control returns to the original step of the image pickup process of FIG. 3. Image processor 160 then performs an image evaluation/display process that evaluates and displays the images evaluated in the image evaluation process of FIG. 3 under control of controller 110 (step S300), which will be described next in more detail in a flowchart of FIG. 5. First, display controller 142 accesses the evaluation value table in memory 170 and then specifies the respective focused blocks of each of the picked-up images (step S301).

Display controller 142 then reads the respective images stored in image memory 150 and forms rectangular frame-like focusing indicators F indicating the respective specified focused blocks of the images on these blocks (step S302). Display controller 142 then displays these images with the indicators as thumbnails arranged, for example, in order of image pickup, such that these thumbnails can be selected by the user (step S303).

The focused block represents a part of the image that is in focus. Thus, the user can recognize focused blocks of each image with the aid of the indicators F formed on the blocks.

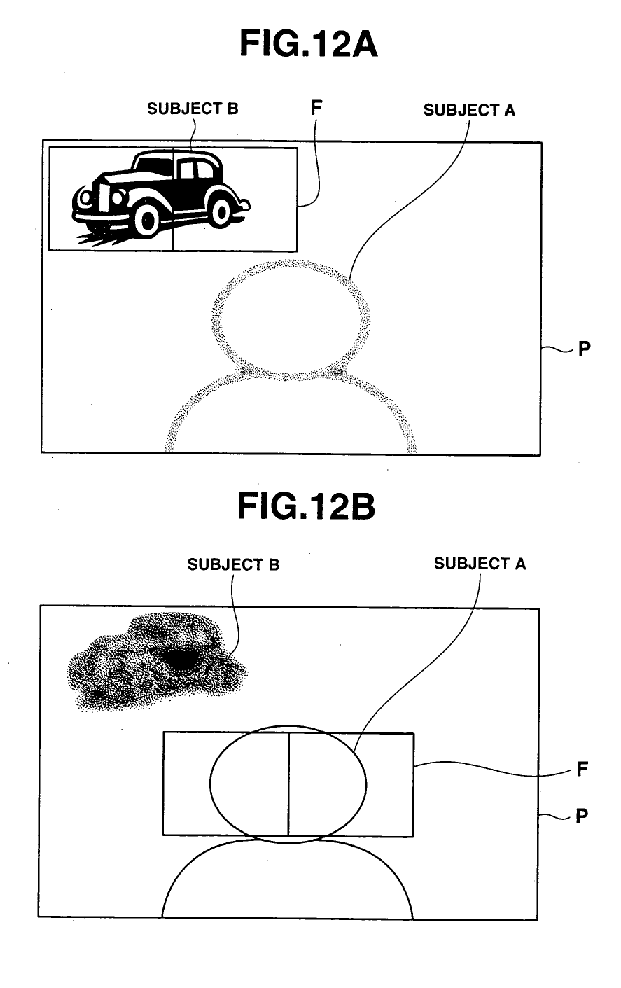

Now, the relationship between focus and depth of field will be described briefly. When the depth of field is low due to image pickup conditions such as lens stopping and shutter speed, focusing can be rarely achieved in the overall focal-distance range of infinity-the closest point. Thus, a focused part of the picked-up image varies from image to image. In an image of a scene in which a distant subject B is in focus, as shown in FIG. 12A, a nearer subject A is out of focus. On the other hand, as shown in FIG. 12B, in a scene in which subject A is in focus, subject B is out of focus.

In the embodiment, a focused block of an image, if any, is indicated specifically by rectangular focusing indicator F. If an image has no focused blocks, no focusing indicators F are displayed on the image.

When these images are displayed as thumbnails together on display 141, the displaying process ends and control then returns to the original step of the image pickup process of FIG. 3.

While in the image evaluation/display process of FIG. 5 the thumbnails are illustrated as arranged in order of image pickup, the display method is not limited to this particular one. For example, instead of displaying of the thumbnails, the respective original images may be displayed sequentially in full size such that each image is displayed throughout the whole display screen of display 141. The images need not be arranged in order of the image pickup. For example, they may be displayed in descending order of the number of focused blocks or in descending order of the number of focused blocks present at a specified position (for example, at the center) of the image. Alternatively, only images in which the number of focused blocks is greater than a predetermined value may be displayed (That is, images having no focused blocks are not displayed). In any case, the respective images are displayed so as to be selectable by the user.

When the picked-up images are each displayed with or without focusing indicator F in the image evaluation/display process in step S300, the user can know the images with focusing indicators F.

When images whose focused parts with indicators F are displayed selectable on display 141 in the image evaluation/display process in step S300 of FIG. 3, control passes to step S106, where the user can select a desired one from the images displayed on display 141. For example, if the user desires to obtain an image where the face of a person A is in focus, the user selects at operation device 132 an image in which focusing indicator F is indicated near the person's head.

When the user selects his or her desired image, controller 110 identifies the image, stores image data representing the image stored in image memory 150 on a memory card of memory 170 (step S106 in FIG. 3), and then terminates this process.

Then, controller 110 clears the image data stored in image memory 150 and information recoded on the evaluation value table in memory 170.

As described above, according to the present invention, the user can obtain an image whose desired part is in focus only by determining the compositional arrangement of the image and then depressing shutter button 131 without performing a focusing operation including the AF lock and switching the AF mode. Thus, even beginners who are not much experienced in image pickup can pick up good images without failure. In addition, even when the beginner focuses the camera intentionally on a specified object, he or she can easily obtain an intended picked-up image.

Even in an environment where the camera is difficult to focus on an object in the AF operation because the contrast of the subject image is low, the image pickup is performed while the focal-distance range is being changed. Thus, an image of the subject in focus is obtained.

### Embodiment 2

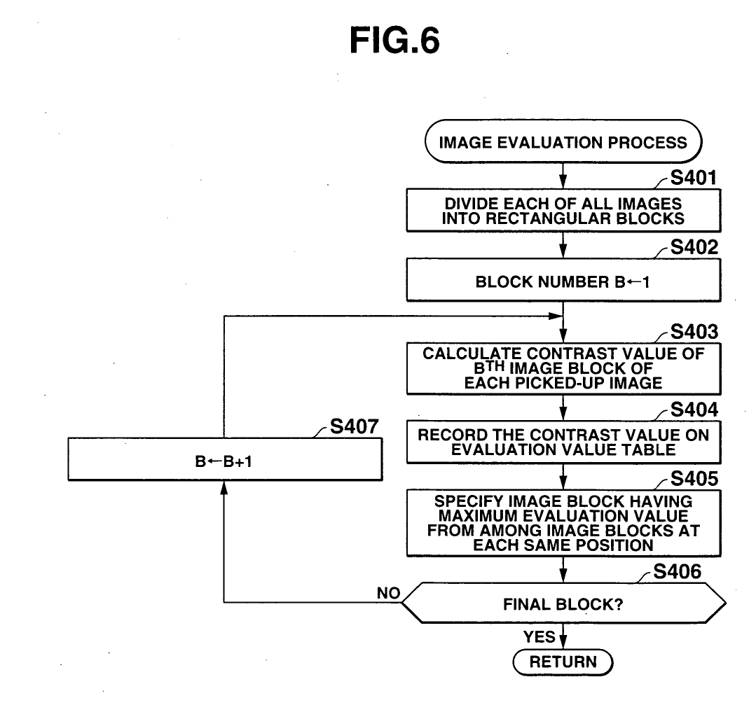

Embodiment 2 is obtained by replacing the image evaluation step S200 of the FIG. 3 process of embodiment 1 with a second image evaluation step S400 of FIG. 6. The second embodiment 2 is characterized in that focusing evaluation values of the ones at each same position of pluralities of blocks into which the plurality of images stored in memory 170 are respectively divided are compared, and respective different blocks of highest evaluation values are recognizably displayed.

The image evaluation step S400 to be performed by image processor 160 of FIG. 1 in the second embodiment 2 will be described in the flowchart of FIG. 6.

As in the processing in step S202 of FIG. 4 performed in embodiment 1, image processor 160 divides all the respective picked-up images P1-P6 stored in image memory 150 into 3×4 (=12) blocks B1-B12 (see FIG. 8) (step S401) Then, image processor 160 substitutes “1” as an initial value into variable B (representing a block number) (step S402), and calculates respective contrast values of blocks B1 at each same position of images P1-P6 (step S403)

Then, image processor 160 records the contrast values calculated in step S403 on an evaluation value table (see FIG. 9) on memory 170 (step S404). The processing in steps S403 and S404 is the same as in steps S204 and S205 of FIG. 4 in the first embodiment 1.

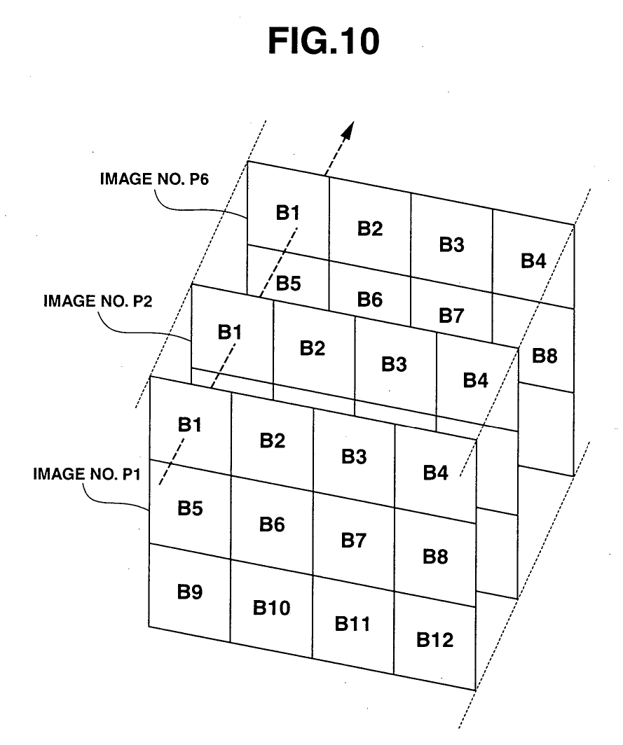

Image processor 160 then specifies a block having a maximum one from among the evaluation values of the blocks at the same block position recorded on the evaluation value table of FIG. 10. Image processor 160 also marks the evaluation value table such that the specified block can be recognized, for example, as shown hatched in FIG. 9 (step S405). Thus, an image with a block having a maximum evaluation value is specified.

Image processor 160 then determines whether the present block-number variable B is final, or represents a final block B12 (step S406).

If not (No in step S406), image processor 160 adds 1 to B and then substitutes a result of the addition into B (step S407). Control then returns to step S403, which then calculates a contrast value of a next block.

In this way, image processor 160 repeats the processing in steps S403-S405, thereby calculating evaluation values of the ones at each same position of blocks B1-B12 of all the picked-up images, and then specifying an image including a block having a maximum evaluation value among the obtained evaluation values, or a best focused one, until the determination in step S406 becomes Yes.

When the images each including a block having a maximum evaluation value at each same position are specified for all the image blocks (Yes in step S406), the image evaluation process of FIG. 6 in this embodiment 2 is terminated. Then, control returns to the original step of the image pickup process of FIG. 3 in embodiment 1.

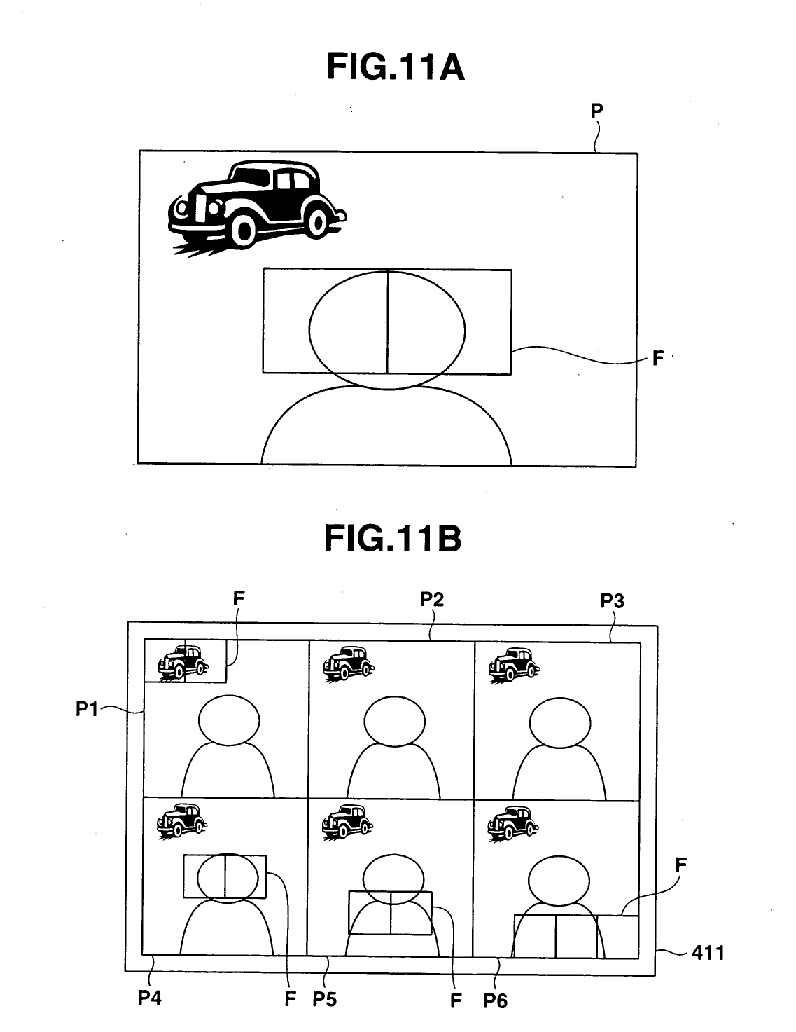

Then, as shown in FIG. 11B, images each with a rectangular frame-like focusing indicator F that specifically indicates that a block thereof has a maximum evaluation value are displayed along with the remaining images without such indicators.

### Embodiment 3

As described above, in the embodiments 1 and 2 the user selects desired ones from the displayed images each with a result of evaluation added thereto in the image evaluation process that was performed in the image pickup process, and then stores only the selected images on the memory card. On the other hand, in embodiment 3, after the image evaluation process an image storing process which stores only the images whose evaluation results are good automatically on the memory card is performed, and then a stored-image arranging process in which the user deletes his or her selected images from the memory card in accordance with the results of evaluation displayed along with the stored images is performed.

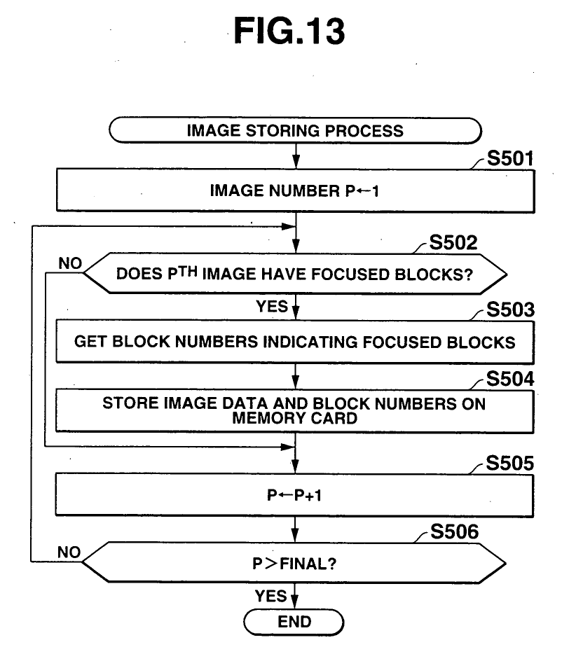

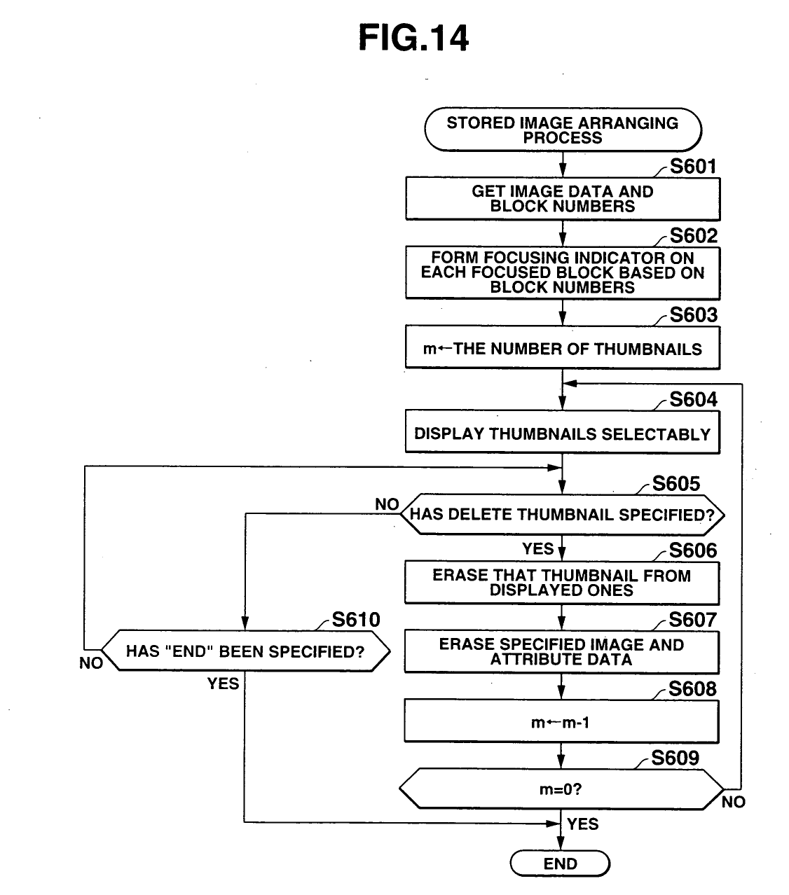

The processing to be performed in the embodiment 3 is obtained by replacing the image evaluation/display and storing processes in steps S300 of FIGS. 3 and 5 and S106 of FIG. 3 with an image storing process of FIG. 13 and a stored-image arranging process of FIG. 14. The image storing process of FIG. 13 comprises storing focused images along with their attribute information. The stored-image arranging process comprises removing unnecessary images and arranging the remaining images.

The image storing process to be performed in the embodiment 3 will be described in FIG. 13.

First, controller 110 substitutes “1” as an initial value into variable P representing the image number of a picked-up image (step S501). Controller 110 then accesses the evaluation value table in memory 170 and determines whether a P^{th} image has a focusing block whose evaluation value is higher than a threshold value (step S502).

If so (Yes in step S502), controller 110 acquires a block number indicative of the focusing block as attribute information (step S503). Then, controller 110 stores image data representing the P^{th} image and its attribute information acquired in step S503 in corresponding relationship on the memory card in memory 170 (step S504).

Controller 110 then adds 1 to P and then substitutes a result of the addition into P (step S505) and then determines whether P+1 is greater than a final image number (P6) (step S506)

If not (No in step S506), controller 110 repeats the processing in steps S502-S504 for the P^{th} image. That is, controller 110 determines whether a next image has a focused block. If so, controller 110 stores the image data and a block number of the focused block as attribute information in corresponding relationship on the memory card.

If the P^{th} image has no focused blocks (No instep S502), controller 110 does not store the image on the memory card, but adds 1 to variable P (step S505).

When the block number exceeds the number of the final image, this process ends (Yes in step S506).

In summary, in this image storing process, only images having focused blocks are stored along with their attribute information representing their block numbers on the memory card.

A stored-image arranging process for selecting desired images from the images stored on the memory card as described above will be described with reference to a flowchart of FIG. 13. The user selects an image select mode on a predetermined menu picture displayed on display 141 by operating operation input unit 132 in order to select desired ones from among the images picked up in the focus bracket image-pickup mode.

Controller 110 then reads image data and associated attribute information from the memory card in memory 170 (step S601).

Then, controller 110 delivers the read image data and the attribute information to image processor 160. Image processor 160 forms focusing indicator F on a focused block of each image based on the attribute information received from controller 110 (step S602).

Display controller 142 constitutes as thumbnails all the images including the ones with focusing indicators F formed by image processor 160, as shown in FIG. 11B. Controller 110 then counts the number of all thumbnails and then substitutes the number into a variable m (step S603)

Display controller 142 displays all the thumbnails with and without focusing indicators thereon selectably on display 141, for example, as shown in FIG. 11B (step S604).

If the user then specifies or selects at input device 132 an unnecessary thumbnail including a block without focusing indicator F to be eliminated from the displayed thumbnails, (Yes in step S605), display controller 142 erases it from the display (step S606). Controller 110 also erases the corresponding image data and attribute information from the memory card in memory 170 (step S607)

Then, controller 110 subtracts 1 from variable m and then substitutes m-1 into variable m (step S608). Controller 110 then determines whether the value of variable m is 0, or there still remain deletable images (step S609)

If not (No in step S609), or there remain selectable images, controller 110 performs processing in steps S604-S609 on the remaining images. That is, controller 110 updates the remaining displayed thumbnails and deletes the displayed thumbnails and data specified by the user.

If there remain no deletable images (Yes in step S609), or a button to terminate this process is depressed (Yes in step S610), this process is terminated. That is, according to embodiment 3, desired images can be selected after the image pickup.

While in the above embodiments images are illustrated as picked up at six different positions of focal distances 1-6, the intervals between these positions and the number of images to be picked up at these positions are not limited to the above-mentioned ones, but optional. The focal-distance position may be determined by controller 110 depending on the image pickup conditions each time an image is picked up. Alternatively, the user may specify the number of images to be picked up and set positions of focal distances at which the images are picked up, as needed. In this case, a time required for lens unit driver 122 to cause lens unit 121 to move in the focal-distance range of infinity to the closest position may be calculated beforehand and a specified number of images may be picked up at a like number of time intervals in the calculated time. That is, the time when the image is picked up may be determined based on the focal distance of the lens or the time elapsed since the lens unit 121 started to move.

In the changeable focal-distance range (for example, from infinity to the closest point), the distances between the positions at which images are picked up are reduced as the number of images increases. Thus, when the lens unit is desired to be accurately focused on a specified subject, the number of images to be picked up should be increased.

While in the embodiments the range of focal distance is illustrated as settable between infinity (or initial position)—(the closest or final position), the user may set any changeable-focal distance range. If the rough distance between the camera and a subject on which the camera is focused is known beforehand, any range that includes the distance may be used as a changeable focal-distance range and unnecessary images are not processed, thereby reducing the processing time. In this case, the user can specify any one or both of the initial and final positions.

The user may select a desired one from among a plurality of picked-up images and record it along with its attribute information. For example, the picked-up image may be recorded along with attribute information that indicates the focal position at which the image was picked up, and then displayed along with the attribute information on display 141. Thus, when images of the same subject are picked up at the same position by changing image pickup conditions including exposure values and shutter speeds, the focal distance at which the subject image is in focus, or the distance between the camera and the subject is known. Thus, these image pickup conditions can be used as a criterion for narrowing the changeable focal-distance range or performing the manual focusing.

While in the embodiments the contrast values are illustrated as used as evaluation values that determine how much the respective parts of each image are in focus, the evaluation values are not limited to the contrast values as long as they indicate the focusing extents of the images.

While in the embodiments the continuous focusing mode is illustrated as prepared selectably, the image pickup mode of digital camera 100 may be only the focus bracket image-pickup mode because in the focus bracket image-pickup mode a good focused image can be obtained only by depressing the shutter button, the usual AF and manual focusing operation are not necessarily required. Thus, the digital cameras are not required to have these functions and can have a simplified structure free from a composition that will be used for measurement of the focal distance required for the AF operation.

Various modifications and changes may be made there unto without departing from the broad spirit and scope of this invention. The above-described embodiments are intended to illustrate the present invention, not to limit the scope of the present invention. The scope of the present invention is shown by the attached claims rather than the embodiments. Various modifications made within the meaning of an equivalent of the claims of the invention and within the claims are to be regarded to be in the scope of the present invention.

What is claimed is:

1. A digital camera comprising:
a lens unit having a changeable focal distance in a predetermined range;
a lens unit driver for driving the lens unit so as to change its focal distance;
image pickup means, responsive to a single image pickup command, for causing the lens unit driver to drive the lens unit, thereby changing the focal distance of the lens unit while picking up a plurality of different images successively;
means for dividing the whole area of each of the plurality of images picked up successively by the image pickup means into a plurality of blocks;
means for calculating a focusing evaluation value of each of the blocks representing how sharp the block is;
means for specifying a well focused block based on the focusing evaluation values of the blocks calculated by the calculating means; and
means for displaying an image that includes the well focused block and an indicator formed on this block indicating that block as a well focused area.

2. The digital camera of claim 1, wherein the specifying means specifies as the well focused one a block whose focusing evaluation value calculated by the calculating means is not less than a predetermined threshold.

3. The digital camera of claim 1, further comprising:
means for recording the images picked up by the image pickup means on a recording medium; and
control means for selecting only the image that includes the block specified by the specifying means among the plurality of images picked up successively by the image pickup means and for causing the recording means to record the selected image on the recording medium.

4. The digital camera of claim 3, wherein the control means controls the recording means such that the selected images and attribute information indicating the blocks of the selected images specified by the specifying means are recorded in corresponding relationship on the recording medium.

5. A digital camera comprising
a lens unit having a changeable focal distance in a predetermined range;
a lens unit driver for driving the lens unit so as to change its focal distance;
image pickup means, responsive to a single image pickup command, for causing the lens unit driver to drive the lens unit, thereby changing the focal distance of the lens unit while picking up a plurality of different images successively;
means for dividing the whole areas of the plurality of images picked up successively by the image pickup means into a plurality of blocks;
means for calculating a focusing evaluation value of each of the blocks representing how sharp the block is;
means for comparing the focusing evaluation values of blocks of the picked-up plurality of images at each same position, for specifying an image including a block that has a maximum one among the focusing evaluation values of blocks of the plurality of images at that same position, and then for further specifying as a focused block on the specified image an image area of the specified image indicated by that block; and
means for displaying images including the blocks specified by the specifying means and having a maximum focusing evaluation value, each block having attached thereto an indicator indicating that block as a focused image area.

6. The digital camera of claim 5, wherein the specifying means compares the focusing evaluation value of each block with a predetermined threshold and then specifies a block, having a focusing evaluation value not less than the predetermined threshold, as a focused one on an associated image.

7. The digital camera of claim 5, wherein the calculating means calculates the contrast value of each block as its focusing evaluation value.

8. The digital camera of claim 5, wherein the images to be displayed by the display means are in the form of thumbnails obtained from the plurality of images picked up successively by the image pickup means.

9. The digital camera of claim 8, wherein the display means displays the thumbnails together.

10. The digital camera of claim 8, further comprising:
means for recording the plurality of images picked up by the image pickup means on a recording medium;
means for giving a command to select an image to be recorded on the recording medium from among the plurality of images picked up by the image pickup means; and
means, responsive to the giving means, for selecting an image to be recorded on the recording medium from among the plurality of images picked up by the image pickup means and for the controlling the recording means so as to record the selected image on the recording medium.

11. The digital camera of claim 10, wherein the control means controls the recording means such that image data representing the selected image and attribute information attached to the image data for specifying a focused block of the image are recorded on the recording medium.

12. The digital camera of claim 11, wherein the control means displays an indicator that indicates the focused block of the image based on the attribute information recorded on the recording medium.

13. An image pickup method of obtaining a good image in a digital camera comprising a lens unit having a changeable focal distance in a predetermined range and a lens unit driver for driving the lens unit so as to change its focal distance, the method comprising the steps of;
responsive to a single image pickup command, causing the lens unit driver to drive the lens unit, thereby changing the focal distance of the lens unit while picking up a plurality of different images successively;
dividing the whole areas of the picked-up plurality of images successively into a plurality of blocks;
calculating a focusing evaluation value of each of the blocks representing how sharp the block is;
specifying a well focused block based on the calculated focusing evaluation values of the blocks; and
displaying an image that includes the well focused block and an indicator formed on this block indicating that block as a well focused area.

14. An image pickup method of obtaining a good image in a digital camera comprising a lens unit having a changeable focal distance in a predetermined range and a lens unit driver for driving the lens unit so as to change its focal distance, the method comprising the steps of;
responsive to a single image pickup command, causing the lens unit driver to drive the lens unit, thereby changing the focal distance of the lens unit while picking up a plurality of different images successively;
dividing the whole areas of the picked-up plurality of images into a plurality of blocks;
calculating a focusing evaluation value of each of the blocks representing how sharp the block is;
comparing the focusing evaluation values of blocks of the picked-up plurality of images at each same position, specifying an image including a block that has a maximum one among the focusing evaluation values of blocks of the plurality of images at that same position, and then further specifying as a focused block on the specified image an image area part of the specified image indicated by that block; and
displaying images including the specified blocks having a maximum focusing evaluation value, each block having attached thereto an indicator indicating that block as a focused image area.
